(19) United States
(12) Patent Application Publication
(10) Pub. No.: US 2002/0005790 A1
(43) Pub. Date: Jan. 17, 2002

(54) Green light (traffic signal) countdown device

(76) Inventor: Phillip Georgalis, Toronto (CA)

Correspondence Address: SIM & MCBURNEY, 330 UNIVERSITY AVENUE, 6TH FLOOR, TORONTO, ON, M5G 1R7, CA

(21) Appl. No.: 09/837,209

(22) Filed: Apr. 19, 2001

Related U.S. Application Data
(63) Continuation-in-part of application No. PCT/CA99/00972, filed on Oct. 18, 1999.

(30) Foreign Application Priority Data
Oct. 19, 1998 (CA) 2,249,686

(51) Int. Cl. G08G 1/096

(52) U.S. Cl. 340/929; 340/907

(57) ABSTRACT

An attachment for a standard traffic light assembly functioning as a precise, real-time, numerically displayed countdown warning device indicating the exact-moment of change from the green to the amber signal. The device will be parallel and visually in-line with the green signal light. A lighted frontal viewing surface will display in sequence the numerals five (5) through one (1) in descending order for a numbered countdown of luminous green light as follows; 5 . . . 4 . . . 3 . . . 2 . . . 1. A blank screen will then coincide simultaneously with the lighting of the amber signal.

### RELATED PATENT APPLICATION

This application is a continuation-in-part application based on PCT patent application PCT/CA99/00972, in which the U.S.A. was a designated country which claims priority to Canadian Patent Application Ser. No. 2,249,686 filed Oct. 19, 1998.

### FIELD OF THE INVENTION

The present invention relates to a numerical countdown device (generally referred to herein as a signal change indicator system) for a traffic signal, to provide a visible indication of the time remaining before a green traffic light changes to amber. In particular embodiments, the signal change indicator system shows only the final five (5) seconds of the green light. The signal change indicator system is intended to be clearly visible to motorists approaching the traffic lights, and to act as a warning of the imminent change of a green light to amber. In the preferred embodiment, the signal change indicator system shows only the final five (5) seconds of the green light prior to signal change. The signal change indicator system is intended to be clearly visible to motorists approaching the traffic lights from 20-40 meters and to act as a warning of the imminent change of a green light to amber.

### BACKGROUND TO THE INVENTION

Traffic light systems control and regulate the flow of vehicular and pedestrian traffic by assigning the right-of-way to one or more conflicting traffic streams, allowing them to pass through intersections and roadways safely and efficiently. Although the current traffic signal systems fulfill the need to convey a clear simple meaning, command the respect of road users and provide a level of convenience and ease of movement, they fail to provide adequate response—reaction time. The response—reaction time is inadequate largely because the transition phase from a green light to an amber light cannot be anticipated or determined by road users. The actual transition point (that fractional moment in time in which one signal changes to another), in this case, green changing to amber, is unpredictable. The point in the traffic light's cycle that can be logically identified as the most important, the transition point, is not clearly defined. The point at which the traffic light system creates a necessity for an immediate decision by an oncoming motorist cannot be accurately determined. Herein lies the fundamental shortcoming of traffic light systems currently in use. If a precise indication of the transition point between the green and amber signal is not conveyed, then drivers entering intersections that may be dangerous or even life threatening are making a crucial decision based on an impulsive reaction.

Within 20-40 meters of an intersection at speeds varying from 50 to 80 km/h, with vehicles and pedestrians converging from every direction, a driver's sensory perception and general awareness are temporarily overwhelmed. Drivers taken unexpectedly by an abrupt change in signal command may be motivated as a result of timing, anticipation, guesswork, instinct, impulse, reflex, advice, assumption, distraction, attention span, focus, fear, anger, frustration, insecurity indecision, individual temperament, risk tolerance, attitude, personal perception, impaired perception, disposition, mood, fatigue, stress, personal objectives, personal justifications, human factors and other intangibles. A congested intersection may not be an appropriate place for a maze of multiple choices. Decisive actions taken by drivers and pedestrians at traffic intersections should be based on a significant level of clarity and certainty.

The effective green interval is defined as the complete duration of the green signal phase minus the momentary transition lapses at the beginning and at the end of the signal change on a conventional traffic light assembly. A warning enhancement system within the transitionary phase of such a traffic light would allow drivers to anticipate and identify the exact moment of the signal change. This indication of the transition point would extend the effective green time to it's maximum limit. Extended effective green time allows for higher volumes of traffic to pass through intersections and results in increased efficiency. A driver's knowledge of transition points would decrease delays by reducing driver response times. The transition point is the crucial link or bridge between the driver and the signal system. An indication of the exact moment of change between signal phases is the only way to solidify this bridge between user and system. Such an indication could greatly decrease brief transition point delays and result in greater efficiency. The increased level of certainty would also improve clarity, awareness and safety.

A number of traffic signal control related devices that offer a warning enhancement means have been proposed in the past. For example, U.S. Pat. No. 3,480,909 to Hines teaches a directional signaling assembly to be used primarily for pluralities of traffic streams at a traffic intersection with a series of three lamps for each direction and a time indicating display means. This replacement assembly has a control unit that is connected to each of the signal lamps and guides their active operation. Gated connections will externally control the operation of two of the signal lamps for each direction, left and right. The third signal lamp for each direction is controlled internally through switching in a pre-determined sequence with the previous two signal lamps. A timing element and switching means sequentially operate the assembly during a programmed timing cycle. A display means visually represents timing information received from logic circuit synchronizations during durations of the timing cycle when one of the two externally controlled signal lamps is operative.

Hines's assembly may be suitable to provide a degree of warning enhancement as it relates to dual or plural direction lane curves and offer a more orderly and efficient method for clearing traffic queues awaiting the right-of-way in such situations but it does not address the need for warning enhancement as it relates to those road user's who require it most, namely those who are travelling straight through the intersection at speeds substantial enough to limit their overall judgement and reaction time.

U.S. Pat. No. 5,726,648 to Soon also teaches a time indicating display as a replacement to a conventional traffic light assembly. A visible time of illumination of seven rectangular “go” indicator lights is provided for an approaching vehicle to determine when the caution indicator light will be illuminated by dividing the time of illumination of the time-indicating display by the number of lights of the five adjacent, rectangular, horizontal light bars that are extinguished between two vertical rectangular light bars. The progressively extinguishing green-lighted bars are meant to be cross-referenced with the main visual reference point embodied by the numerical visual display. Drivers make determinations through a calculation of time remaining before signal change based on comparative reference with this multiplicity of staged lighting.

Separated from it's coordinated function with and direct relationship to counteractive lighting, Soon's time indicating display offers no indication of when the signal will change. Soon's time indicating display is static and non-changing, and it does not provide an indication of the remaining duration of the green signal in and of itself. The numerical display and subsequent need for reference against visual illumination and/or extinguishing of counteractive lighting forces approaching drivers already over-burdened with a number of time, distance, velocity and judgement parameters to face yet another complex split-second decision through the deciphering of signal commands by dividing the illuminated lights with a referenced time indication. This assembly could act to confuse approaching drivers further and actually impede or interfere with a decisive reaction.

U.S. Pat. No. 5,519,30 to Casini teaches a pedestrian-oriented traffic signal assembly with attached time indicating display. The traffic light timer within this assembly can be constructed as an integrated unit or as an appendage to a conventional “Walk/Don't Walk” sign. Graphics, including an appropriate pictorial icon together in a single display, will face the oncoming pedestrian traffic. A backward counting timer means is initiated each time the traffic timing circuit changes states across all stages including red, yellow (amber) and green traffic lights. The graphic generating means extends from a secondary vertical leg of the attachment and continuously displays the time, in seconds, remaining before the traffic timing circuit again changes states.

A continuous numerical display as disclosed by Casini does not emphasize the vital final seconds of the green signal indicator. The crucial segment of time of importance to pedestrian and driver alike is the final few seconds in the duration of illumination of the green. A continuous display fails to emphasize this crucial time and may even act to diminish it's impact by drawing attention of road users away from it and towards periods of lesser importance. The fundamental shortcoming of this assembly is that it is intended to provide a warning enhancement for those present at an intersection who offer little or no potential threat that may result in serious bodily injury or a safety concern to others, namely, the pedestrian. It fails to address the need to enhance a warning function as it relates to the driver, the individual operating a vehicle travelling at substantial speeds through an intersection, that may present an ominous threat to themselves and others.

U.S. Pat. No. 4,590,455 to Fritzinger teaches a traffic signalling system that has the green indicator or the green and red indicator blinking at predetermined intervals before the direction of oncoming traffic is changed. A visible marker placed at an appropriate distance from the intersection allows approaching motorists to make determinations based on their relative location to the blinking of a visible marker. This system may also work in tandem with a semi-actuated controller that is synchronized with the yellow (amber) caution signal creating a timing link between the blink signal and the illumination of the yellow indicator.

Fritzinger's system and apparatus does offer some degree of warning enhancement in it's specific applications but the indications are imprecise and may be confusing to the motorist. A blinking signal as it relates to a change in traffic direction is generally understood and widely accepted but there is no such correlation with a signal command intended for vehicular traffic travelling straight through an intersection. This system and apparatus does not address the need for warning enhancement from conventional, linear lines of approach nor does it offer the necessary degree of precision required for maximum effectiveness and utility in such situations.

U.S. Pat. No. 3,408,623 to Wagner teaches a traffic signal assembly that features a multiplicity of staged lighted bars that progressively extinguish or illuminate to indicate the time remaining before a signal changes. Like other assemblies of this nature, this method is somewhat imprecise, and requires some form of interpretation by the road user. A further disadvantage is the absence of any time indicating display in this assembly. With no frame of reference other than the lighted bars, this system may offer an alternative to a conventional assembly but any improvement in terms of warning enhancement may be nominal.

U.S. Pat. No. 4,827,258 to Evans teaches a traffic light change warning system that implements the simultaneous activation of the green with the amber signal and/or the red with amber signal to alert the motorist or pedestrian that the light is about to change. This method may be somewhat ambiguous and inexact to the observer. A further disadvantage is the absence of any time indicating display means within this method. The combined usage of lighted signal indications whose command meaning is firmly established and understood may act to undermine or weaken the command meaning's originally intended representative purpose.

U.S. Pat. No. 5,294,924 to Dydzyk teaches a compact, modular type, ambient light sensitive flashing device. This device is removable and exhibits periodic blinking that may alert oncoming traffic of undesirable road conditions. This light sensitive flashing device may be attached or set into the upper portion of a conventional traffic light assembly through a bored pilot hole provision. A tapered attachment leg may be sized and adjusted to secure the device firmly from behind to the conventional assembly's housing. It may also be appended to similar traffic control assemblies with an adapted bracket or fastener. A photocell is interfaced between the light bulb and a battery voltage source to actuate bulb illumination through ambient light conditions.

Dydzyk's light sensitive flashing device may be appropriate for specific applications involving hazardous road conditions but it is not suitable for general, widespread use. While it encourages a more cautious approach towards an intersection, it fails to offer an accurate indication of signal duration or transition. In this sense, it may offer a relatively effective temporary measure but fails to address the need for a more permanent, ongoing warning enhancement at typical intersections under ordinary circumstances and conditions.

Ultimately, while the objectives of the previously mentioned innovations relating to the warning enhancement of traffic signal systems may be somewhat similar to the present invention, these and other examples of the prior art would not be suitable for the purposes, functional means and method of implementation and integration of the present invention as herein described and disclosed.

### SUMMARY OF THE INVENTION

It is therefore an object of an aspect of the present invention to provide a time indicating device to be attached to a standard, conventional, currently in-use traffic light assembly that avoids the disadvantages of the prior art.

Another object of an aspect of the present invention is to provide an attachment for a standard traffic light that is easily understood by road users and easily integrated into the universally accepted, generally understood current functioning of such a standard traffic light.

Another object of an aspect of the present invention is to provide an attachment for a standard traffic light assembly that is straightforward and inexpensive to manufacture and install for various traffic control applications.

Another object of an aspect of the present invention is to provide an attachment for a standard traffic light assembly that provides a visual display countdown indicating in particular the final five seconds of the duration of illumination of the standard traffic light assembly's green light.

Another object of an aspect of the present invention is to provide an attachment for a standard traffic light assembly whose visual display countdown warning means will cease simultaneously with the subsequent illumination of the host traffic light assembly's amber light and remain dormant through such an assembly's pre-determined time duration and typical light phase sequence of amber illumination, followed by red illumination, followed by green illumination until a switching means re-activates the timing system to coincide once again with the final pre-determined seconds e.g. the final five seconds of the duration of illumination of the standard traffic light assembly's green light.

Another object of an aspect of the present invention is to provide an attachment for a standard traffic light assembly that alerts drivers of the exact remaining duration of illumination of the green signal and the beginning of the amber signal's inherent warning transition prior to the impending red signal command to stop.

Another object of an aspect of the present invention is to provide an attachment for a standard traffic light assembly that prevents the driver of a vehicle approaching an intersection at substantial speeds from having to accelerate quickly to clear the intersection or stop abruptly to avoid running the red light.

Another object of an aspect of the present invention is to provide an attachment for a standard traffic light assembly that reduces the probability of serious accidents and bodily injury to drivers and pedestrians at intersections by allowing all road users to avoid split-second impulsive decisions and instead apply informed decisions based on a clear, forewarned awareness of precisely when the appropriate time to stop is at hand during signal transition.

Another object of an aspect of the present invention is to provide an attachment for a standard traffic light assembly that allows drivers encroaching upon an intersection from a distance of 20-40 meters away to make a sensible determination of whether to continue or bring their vehicle to a complete stop.

Another object of an aspect of the present invention is to provide an attachment for a standard traffic light assembly that encourages consistently uniform and evenly distributed traffic flow through the creation of a smoother, more controlled and more predictable and therefore safer traffic intersection environment.

Another object of an aspect of the present invention is to provide an attachment for a standard traffic light assembly that provides a numerical visual display in real time representing a countdown duration in seconds that may be universally recognized, understood and observed.

Another object of an aspect of the present invention is to provide an attachment for a standard traffic light assembly that does not interfere with, hinder, obstruct or alter the fundamental functioning of the host traffic light but rather accentuates and enhances that functioning by drawing attention to a crucial moment of transition between the green and amber signals which is of vital importance to the road user.

Another object of an aspect of the present invention is to provide an attachment for a standard traffic light assembly that has an outer perimeter that provides a visor or similar protrusion to shield the device's display surface from reflection or glare from outside light sources and ensures that the numerical visual display is always clearly outlined and visible to observers.

Another object of an aspect of the present invention is to provide an attachment for a standard traffic light assembly that may be used in conjunction with punitive deterrents to red light running at intersections such as red light camera installations. This would benefit road users, law enforcement officers and court officials in resolving disputes involving the allocation of responsibility and liability arising from intersection related situations.

Accordingly, one aspect of the present invention provides a signal change indicator system for a traffic control system, said traffic control system having green, amber and red lights disposed and lit in sequence for said control of traffic, said signal change indicator system having a numerical display showing time in seconds, said numerical display being adjacent to and visually aligned with the green light and showing a pre-determined number of seconds remaining prior to a signal change from green light to amber light.

In preferred embodiments of the signal change indicator system of the present invention, the numerical display shows not more than the final ten seconds, especially not more than the final five seconds, prior to a signal change from green light to amber light.

In another embodiment, the numerical display is blank at all times other than during said display of time remaining prior to a signal change from green light to amber light.

In a further embodiment, the numerical display is additionally shown at a location spaced from said green light, in advance of the traffic control system.

In further embodiments, the numerical display ceases when the traffic light changes from green to amber.

In still further embodiments, the traffic control system has more than one green light oriented in a direction, each of said green lights having a numerical display associated therewith. The green light may show directional arrows. Moreover, the green light may include a flashing green light and a continuous green light, each of said flashing green light and continuous green light having a numerical display associated therewith.

Another aspect of the present invention provides a numerical countdown display in modular form for vehicular traffic lights having green, amber and red lights disposed and lit in sequence for control of traffic, said timing module system having a numerical display showing a pre-determined time in seconds remaining prior to a signal change from green light to amber light, said numerical display being blank at all times other than during said display of time remaining prior to the signal change from green light to amber light.

In a preferred embodiment of the numerical countdown display, the pre-determined seconds are not more than ten seconds, and especially not more than five seconds.

In another embodiment, the numerical countdown display is adjacent to and visually aligned with the green light.

A further aspect of the present invention provides an attachment for an in-use traffic light assembly consisting of a red, amber, and green lights, said attachment being mounted and secured parallel and visually in-line with the green light to function as a traffic warning device, said attachment having a real-time, numerical visual display countdown indicating a final predetermined number of seconds of the duration of illumination of the green light, the visual display countdown ceasing to function simultaneously with a change of the lights in said traffic assembly from a green light to an amber light and functioning again only when the green light is illuminated and then only when the green light has the pre-determined number of seconds prior to a change to amber light at which time the visual display is reactivated and functions until the green light changes to amber, thereby providing a precise warning indication of the moment of change of the lights of the traffic light assembly from green light to amber light.

In preferred embodiments, the attachment further comprises

a) a digital processing means to control said countdown; and

b) a timer that is activated by said digital processor to effect said visual display.

In further embodiments, the attachment further comprises:

i) an integrated circuit with digital processing, logic and memory means to control said countdown; and

ii) a timer that is activated by said processing, logic and memory to effect said visual display.

In embodiments, the final pre-determined number of seconds is not more than ten, and especially not more than five seconds.

In another embodiment, the visual display has dimensions not exceeding 50 cm in height and 40 cm in width.

Another aspect of the present invention provides a signal change indicator system for a traffic control system having green, amber and red lights disposed and lit in sequence for said control of traffic, said signal change indicator system having a numerical display countdown showing time in seconds remaining prior to a signal change from green light to amber light, said numerical display being adjacent to and aligned with the green light and showing the final five seconds of signal duration prior to the signal change from green light to amber light.

In a preferred embodiment, said numerical display has dimensions not exceeding 50 cm in height and 40 cm in width.

### BRIEF DESCRIPTION OF THE DRAWINGS

The present invention is illustrated by the embodiments shown in the drawings, in which:

FIG. 1 is a schematic representation of apparatus of the invention, showing a staged sequence of descending numerical characters 5 through 1 on the modular timing section followed by a blank screen;

FIG. 2 is a schematic representation of a frontal view of apparatus of the invention, visually in-line and parallel to the green light;

FIG. 3 is a schematic representation of a rear view of apparatus of the invention mounted to the steel frame of a traffic light;

FIG. 4 is schematic representation of a perspective view showing a modular timing section of the apparatus of the invention;

FIG. 5 is a schematic representation of a frontal perspective of the display portion of the modular timing section;

FIG. 6 is a schematic representation of the structure of a rear view of the modular timing section;

FIG. 7 is a schematic arrangement of an LED number of the modular timing section;

FIG. 8 is a cut-away perspective view of the display portion of FIG. 5;

FIG. 9 is a schematic representation of an electronic circuit for the apparatus;

FIG. 10 is a schematic representation of the modular system's numeric display;

FIG. 11 is a schematic representation in staged block diagram form of use of the invention; and

FIGS. 12A-12C are schematic representations of various assembly installations with transformer connection.

### DETAILED DESCRIPTION OF THE INVENTION

The present invention relates to a modular timing system, generally referred to herein as a pre-emptive signal change indicator system or more particularly as a signal change indicator system, for a standard traffic light assembly which provides a precise, real-time, numerical display countdown warning, indicating the exact moment of change from a green traffic signal to the amber signal, and to the related apparatus.

In embodiments of the invention, the signal change indicator system is in the form of a roughly square, fully insulated and thoroughly sealed enclosure of moulded or pressed plastic with limited depth. It is understood that the shape and the materials of construction maybe varied widely, subject to requirements for attachment to or near traffic lights and the ability to withstand environmental conditions. The perimeter of the enclosure may be sealed with a resilient, impervious steel frame bordering a frontal viewing face of plexiglass. The system displays a series of lighted and clearly defined numerical symbols through a translucent or reflective means over a dark, contrasting background. The numerical representations or symbols are displayed in sequence, in descending order and in real time. Normally, the seconds remaining prior to the light change are displayed.

The signal change indicator system is synchronized to the primary contact circuit within the traffic light. The system may employ it's own integrated circuits, digital and/or manual switching, transistors, digital relays, clock circuit and digital timers and other electronic circuitry, so as to perform the function of visually representing and displaying numerals e.g. 5 through 1 in descending order, i.e. to count down the remaining 5 seconds of real time left on the pre-set cycle of the timer program that exists within the green light controller on a standard traffic light assembly. It is understood that larger or shorter time periods could be used in the countdown, although 5 seconds is preferred.

In embodiments, apparatus of the present invention provides three (3) parallel and rigid fastening arms extending from one side of the rear housing enclosure. These three parallel fastening arms have flat-ended connecting surfaces that lie flush to the existing steel frame of the traffic light and are provided with pilot holes for securing the apparatus of the signal change system to the frame with nuts, bolts or rivets as required. The fastening arms may be located on either side of the protective enclosure of the signal change indicator system, depending on installation requirements. For instance, the arms will be located on the right side of the system for a left hand traffic light and conversely, on the left side of the system for a right hand traffic light.

In particular embodiments, the signal change indicator system is intended to be a parallel installation to the green signal on a standard traffic light. Thus, it will be mounted parallel and visually in-line with the green light, emitting green fluorescent light similar in tone to that of the green signal light's emittance. The system will not add unnecessary bulk to the appearance of the traffic assembly and any additional width will in no way hinder or obstruct any vehicles that may be passing through the intersection as clearance provisions will remain the same. The system needs to be of a size that provides easy visibility to motorists. In particular, the system should be not more than 50 cm×40 cm×12 cm.

The present invention may utilize LED (Light Emitting Diodes) for visual transmission of pre-determined numerals e.g. 5 through 1 in the countdown, or a display. In the case of the LED display, the recombination of positively and negatively charged particles and the by-product of heat and light would illuminate translucent semi-conductor materials e.g. GaP or Gallium Phosphide, to provide current and emitted light for a typical seven segment LED numerical display. As the actual LED surface is small, light pipes would be employed so to enlarge the lighted surface, as illustrated below. In the case of a segmented fluorescent display, seven segment or multi-segmented numerical symbols are represented on a board matrix with 8columns along 12 rows. One side of the board is fluorescent green and the opposing side of the board is uniformly black pixel. Mechanical levers, relays or pins activate segments through a twisting motion, exposing the luminous side of the black pixel side as required. Within the framework of the display, light travelling through tubes or a quartz prism will be bent to strike the surface of the board as squarely as possible thus creating a reflective illumination. The numerals in the countdown may comprise transmitted light or a reflected light as required. Other signal systems may be used.

A digital controller may be used with processors programmed with a series of logic pins and gates that will control the sequence of lights on the seven-segment display, preferably LED display. The sequence of lights will represent a descending countdown of pre-determined numerals e.g. five (5) through one (1), to then be followed by a blank screen. The integrated circuits, timer means, clock circuit, digital or electromechanical switches, logic and memory means will be directly connected to the primary circuit of the traffic light and will remain perfectly synchronized through the use of logic or code circuits which perform redundancy checks and ensure perpetual synchronization with the existing traffic light's pre-set timer, or specifically, the remaining seconds of real time on the green signal's timer that it will display.

In another aspect of the invention, the control circuit of the signal change indicator system may have an adjustment to register the length of the green signal phase as programmed according to specifications of ministry of transportation and/or traffic engineers. Duration of pre-timed settings may be entered into the control circuit and initiate the clock circuit controlling the last seconds to be registered by the countdown numerical display. When the green signal of the traffic light goes on, voltage saturation activates relays which in turn activate the control circuits and relevant processors to begin time synchronization and display for descending numerical countdown, i.e. 40 second total green light duration is registered in the control circuit so that at t=35 seconds (or other pre-determined time) the descending countdown is initiated.

Another embodiment of the invention would employ a built-in transformer or transformer connection for compatible voltage from the existing hard-wired electrical cable running from the hydro-pole power source along with the associated field wiring. The system will derive all electrical power requirements from existing power sources utilized by the traffic light assembly. The signal change indicator system should exhibit low power consumption, preferably below 30 volts and operate at a standard frequency of 60 hertz. Operating at standard frequency will encourage maximum compatibility and synchronization between the timer means of the existing traffic light assembly and the timer of the signal change indicator system.

Another aspect of the invention provides that the system will be embodied in a modular form, e.g. a display section in a frame or casement. The display section will contain all of the related hardware and software necessary to perform it's intended function. The casement, e.g. steel casement enclosure that the display section is inserted into, would be physically mounted to the steel frame of the traffic light. The mountable enclosure will serve as a permanent, fixed housing and provide protection against a variety of outdoor elements such as reflective light interference and weather conditions.

Yet another aspect of the invention provides that all of the digital/electronic components within the module will perform exact synchronization to the existing circuitry of the traffic light as it relates specifically to each individual unit. The pre-programmed phase sequence and timing durations of the host traffic light would determine the activation and deactivation points of the system. There would be integration of circuits, processors, timers, switches, relays, memory and logic, which may be used in a variety of ways.

In embodiments, the system would always be activated when a pre-set time (pre-determined time) e.g. precisely five (5) seconds, remains in the duration of the green signal. The system would always be de-activated simultaneously with the lighting of the amber signal. Thus, following the initial installation and interface, there will be no manual programming requirements by traffic engineers or otherwise. The characteristic behavior of the present invention would reflect the pre-programmed behavior of it's host traffic light assembly.

The present invention is illustrated by the embodiments shown in the drawings.

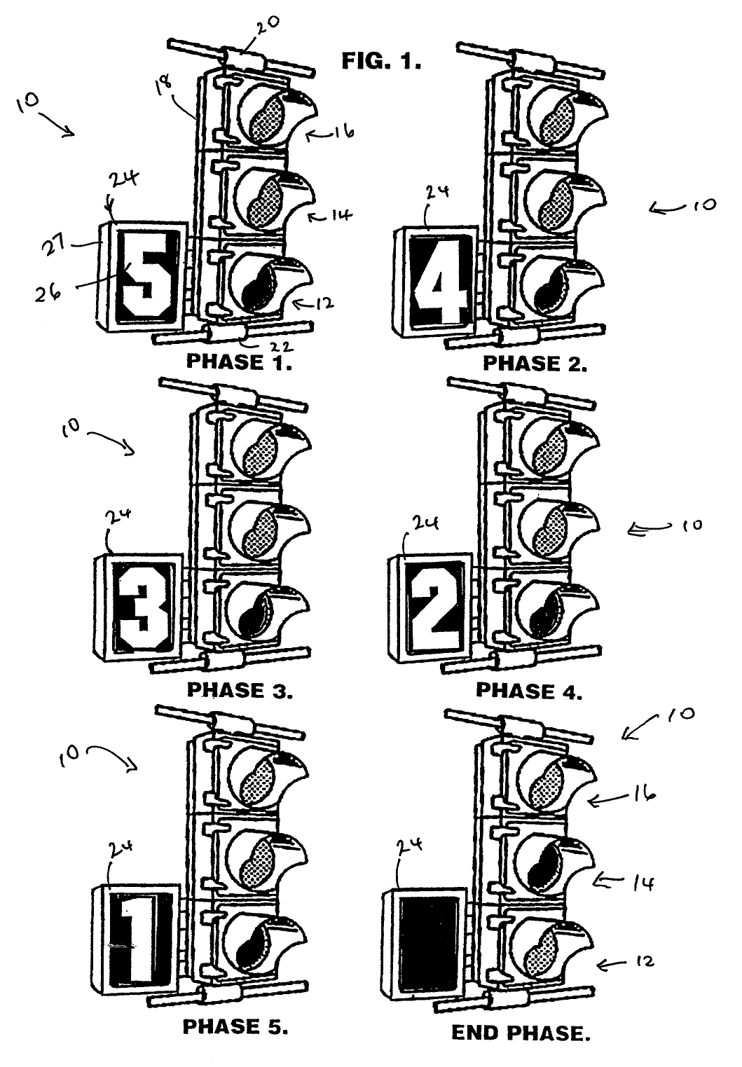

FIG. 1 is a schematic representation of the present invention, being a traffic light with a modular signal change indicator system attached thereto, showing phases of the countdown towards the change of the light from green to amber. The traffic light is a conventional traffic light, which may have a wide variety of configurations. In the apparatus shown, apparatus 10 has a green traffic light 12, an amber traffic light 14 and a red traffic light 16, of which green traffic light 12 is shown as being lit. Traffic lights 12-16 are supported by frame 18 that is mounted at attachments 20 and 22. Signal change indicator system 24 is attached to frame 18, being attached to frame 18 adjacent to green traffic light 12. Signal change indicator system 24 has numerical module 26 in casement 27.

In phase 1, signal change indicator system 24 is shown as displaying a number, 5. This represents a time of 5 seconds until the green light turns to amber, i.e. the time when green light 12 ceases to be lit and amber light 14 becomes lit.

FIG. 1 shows phases 1-5 in which the numeral on the signal change indicator system 24 changes from 5 to 1 in sequence at intervals of 1 second. In the section of FIG. 1 identified as “end phase”, the signal change indicator system is not lit, which coincides with amber light 14 being lit, rather than green light 12.

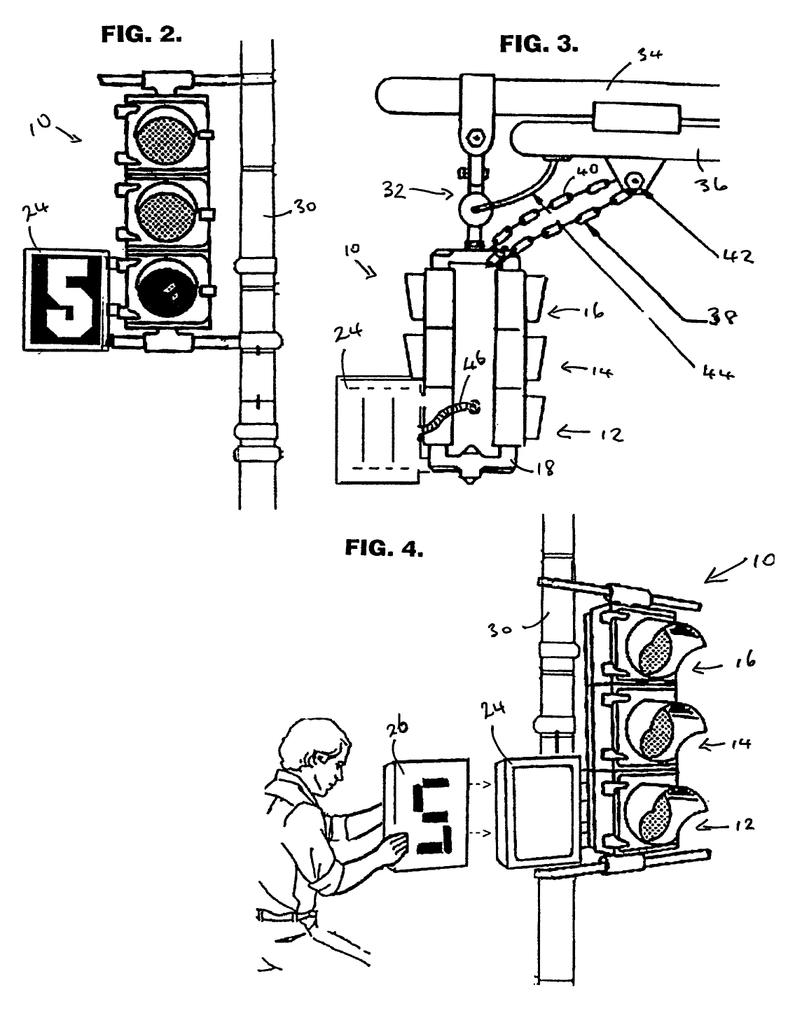

FIG. 2 shows a front view, visually-line and parallel to the green, which is the orientation that would be viewed by a motorist approaching the traffic light system. The traffic light system would be attached to pole 30. Any convenient means may be used.

FIG. 3 shows an embodiment of the present invention, from a rear perspective. Apparatus 10 has green light 12, amber light 14 and red light 16 attached to frame 18. Signal change indicator system 24 is also attached to frame 18. Apparatus 10 is suspended from brace 34 by suspension system 32. Brace 34 has electrical conduit 36 attached thereto. Apparatus 10 is further supported by chains 38 and 40 that are attached to bracket 42 on electrical conduit 36. Electrical cable 44 extends from electrical conduit 36 into suspension system 32 and then connects to green light 12, amber light 14 and red light 16. Electrical cable 46 extends from the rear position of apparatus 10 into signal change indicator system 24.

FIG. 4 illustrates the modular nature of signal change indicator 24, in that numerical module 26 may be removed from the signal change indicator system 24. It is to be understood that numerical module 26 does not have a number 5 permanently etched into the module, but that the number 5 merely represents the numerical nature of the module being inserted.

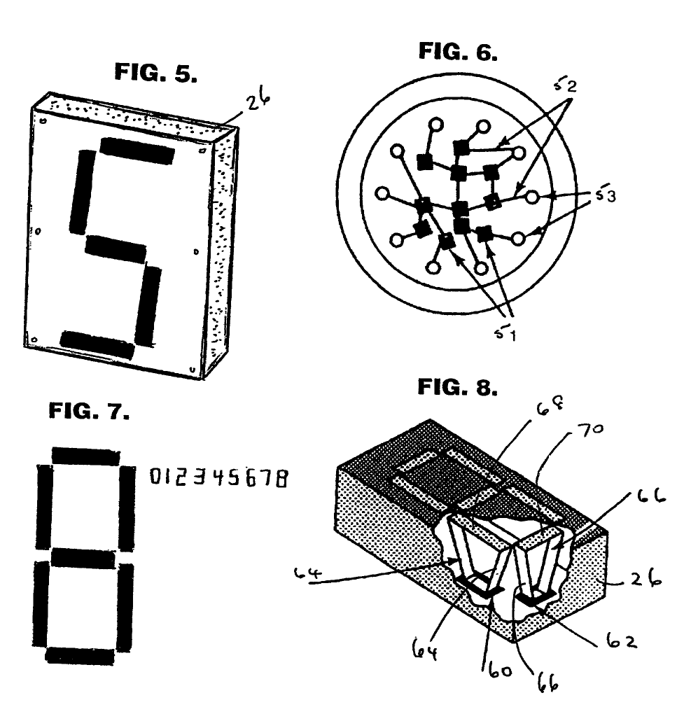

FIG. 5 shows a perspective view of the numerical module 26.

FIG. 6 shows an enlarged schematic representation of the structure of a preferred internal component of the numerical module 26, being a multi-chip integrated circuit having discreet, active components (diodes) 51, connecting wires 52 and terminals 53, which are used as part of the control of the numerical sequence shown on the front of the modular time-indicating device.

FIG. 7 shows a typical schematic arrangement for LED numbers, with the appropriate sections of the LED number being lit in order that the appropriate number is shown.

FIG. 8 shows a schematic representation, partially in section, of numerical module 26. Numerical module 26 has a plurality of LEDs, two of which are indicated by 60 and 62, with accompanying light pipes 64 and 66 that extend from LED substrate 68 and 70. It is understood that each of the LED segments shown on numerical system 26 would have corresponding LEDs and light tunnels.

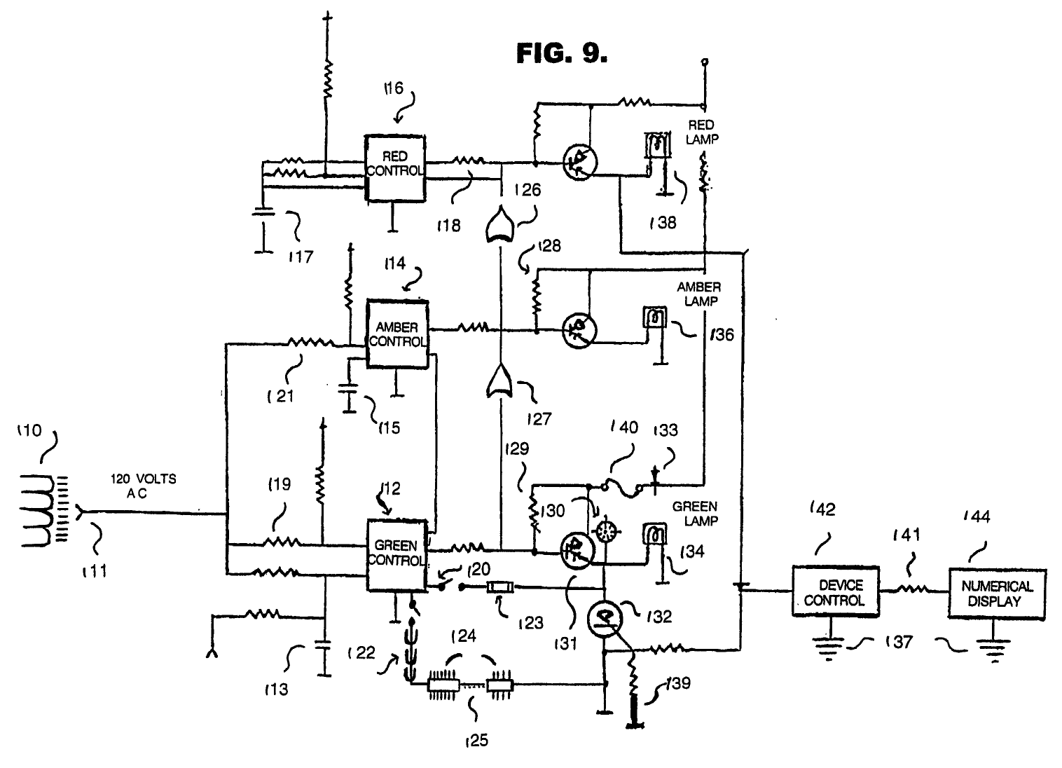

FIG. 9 is a schematic representation of an example of an electrical diagram for the function of the signal change indicator system as part of a conventional, currently in-use traffic light assembly. It is understood that other electronic or computer systems may be used. In the embodiment illustrated, core transformer 110 employs the principle of mutual induction to convert variations of current and voltage from the primary circuit into the necessary variations of current and voltage for the modular system 142. The modular system 142 has a centre tap 111 to which the supply voltage is connected. Grounded condensers 113,115,117 consist of conducting plates separated by thin layers of non-conductive dielectric and which permit the necessary storage of energy as a result of electric displacement between the opposing sides that are oppositely charged by the voltage source. A level of capacitance is maintained through a difference of potential in proportion to surface charge.

The electrical energy requirements then continue through the circuit to the green control unit 112, the amber control unit 114, and the red control unit 116, with various resistors 118,119,121 acting to offer protection to the circuit by exhibiting electrical resistance to maintain current control during operation. Current flow may be disrupted or initiated by conventional single pole switching 120 or transistorized junction type 123 switching through biased on or biased off maximum possible collector current level across the transistor. Devices similar to common collector transistors 131 and 132 may be employed to amplify d. c. or steady-state voltages with a simple fixed-current bias common emitter arrangement. Relatively high output from the voltage source 110 can also be matched at the detector (also known as the rectifier) 133 where alternating current 140 can be converted to direct current if necessary. Further resistors 128,129 offer protection through current control and electrical resistance.

A standard measure timer means 130 may initiate the beginning or end of an interval of time that either starts or stops the timing function at predetermined durations as required by the synchronous requirements of the host traffic light's green signal indicator. In these applications, semi-conductive base transistors 131 with emitters and collectors are continually transferring electrical signals across various resistors 121,128, 129 and resistive components.

Similarly, the current to control elements, viz. logic gates 126,127, determine anode to cathode voltage at which the device commences to conduct. These logic gates ensure that the timing system is initiated only during the desired segment of the green signal of the traffic light and not during the sequence of the amber and red signals. A redundancy means within the logic means 126, 127 will maintain a continuous series of redundancy checks to ensure accuracy. Logic gates or pins 122 also utilize Boolean algebra to filter voltage highs and lows through and/or type input and output terminals.

Off-the-shelf multi-chip integrated circuitry packages 124 with interfaced metallic wiring 125 are implemented to perform the complicated digital microprocessing and to execute relevant data control and command functions within modular system 142. Mass produced, monolithic integrated circuits such as that represented in FIG. 6 with fabricated, diffused components 51, 52 and 53 would be most suitable.

The filaments within the electric lamps of the conventional traffic light assembly 134, 136 and 138 radiate light when heated to incandescence by the electric current. The LED display 144 of the present invention will be operated in a forward biased direction represented by the electromotive force multiplied by the current. In an A.C. signal 140, the current is sinusoidal with a peak value of e.g. 10 volts applied to each of the circuits. In the LED numerical display 144 when electrons recombine with holes across an N-P junction 124 such as those in the transistors 131, the actual movement of the electrons in relation to the conduction band and valence band will show many paths for the electrons. When electrons fall from a higher to a lower level, the energy portion will be converted into light. In this instance, a gallium phosphide diode with an energy gap of 2.25 ev. that corresponds to a wavelength of 5600 A may be used, which will result in the emiftance of a green light.

Covalent bonds within the LED portion of the device 44 may be broken by an increase in outdoor ambient temperature, which would materially reduce light output from the translucent junction of semi-conductor material that provides the light source. The actual LED device is very small, and to enlarge the lighted surface, solid plastic light pipes may be employed. The LED is operated in a forward biased position and will have very low values of reverse voltage breakdown. It will possess a relatively high forward voltage drop (0.8 to 1.2 V) in comparison to diodes designed for a rectifier or detector in a general power supplier. The LED display of the device 144 should have the advantage of long life and ruggedness. It will be switched on and off by means of a transistor circuit similar to 132. Transistor saturation voltage will be approximately 0.2 V and a resistor 141 will be necessary to limit the current through the LED to the desired level.

The values of all necessary components and their proper configuration within the conventional traffic light assembly's circuit complete the integration and synchronization with modular system 142. This in turn guides and ensures that the numerical visual display means 144 is initiated and interrupted at the required pre-determined intervals. All connections are brought to a common ground 137 to prevent ground faults. Excess current may also be grounded through a main bleeder 139, the equivalent of a large draining resistor.

The screen of the signal change indicator system may have a fine film of aluminum adhered on the surface at which the emitted light strikes. This permits the light beams to pass through, but collects the secondary electrons and conducts them to ground 137. The aluminum film also improves the brightness of the glow by reflecting emitted light towards the glass. A further advantage of the film is that it acts as a heat sink, conducting away heat that may accumulate on the surface.

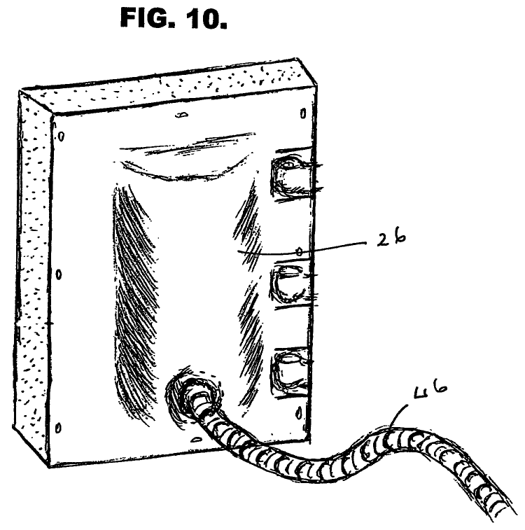

FIG. 10 shows a rear view of the signal change indicator system, with electrical cable 46 being attached to the rear of numerical module 26.

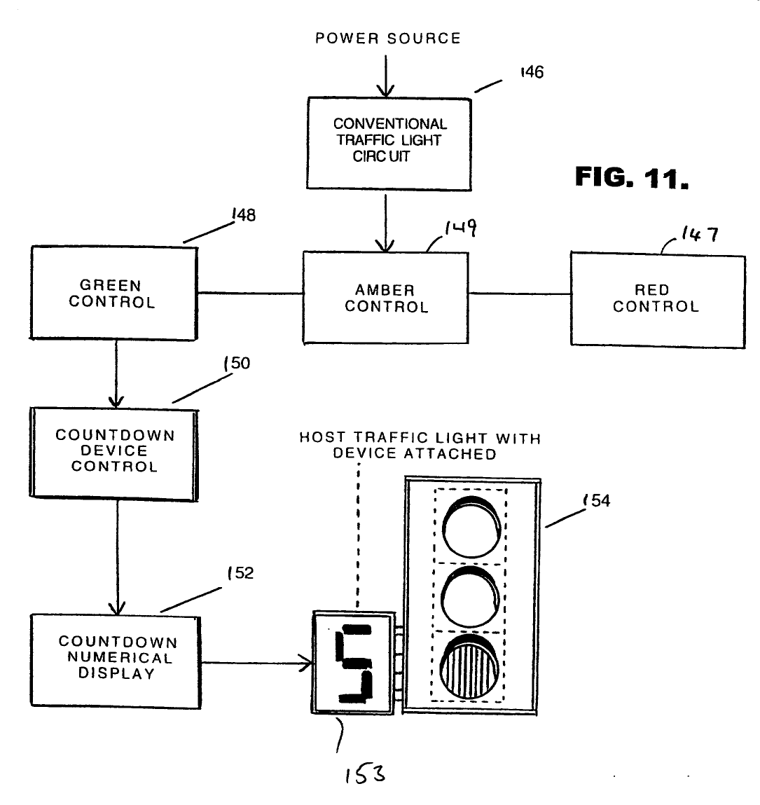

FIG. 11 shows a staged block diagram of use of the invention. A power source is connected to conventional traffic light circuit 146. This circuit is connected to green light control 148, amber light control 149 and red light control 147. Green light control 148 is connected to countdown numerical display 152. Countdown numerical display 152 controls the illumination of the numerical sequence on modular system 153 of traffic lights 154. Thus, the components of the signal change indicator system become part of the conventional ‘traffic light circuit 146, the amber and red control’ units are bypassed and a connection is made only between the green control unit 148 and the countdown device control. The countdown device control 150 initiates or interrupts and guides the operation of the countdown numerical display 152. The signal change indicator system is attached and secured to the optical lens housing of a conventional traffic light assembly 154 visually in-line with the green optical lens.

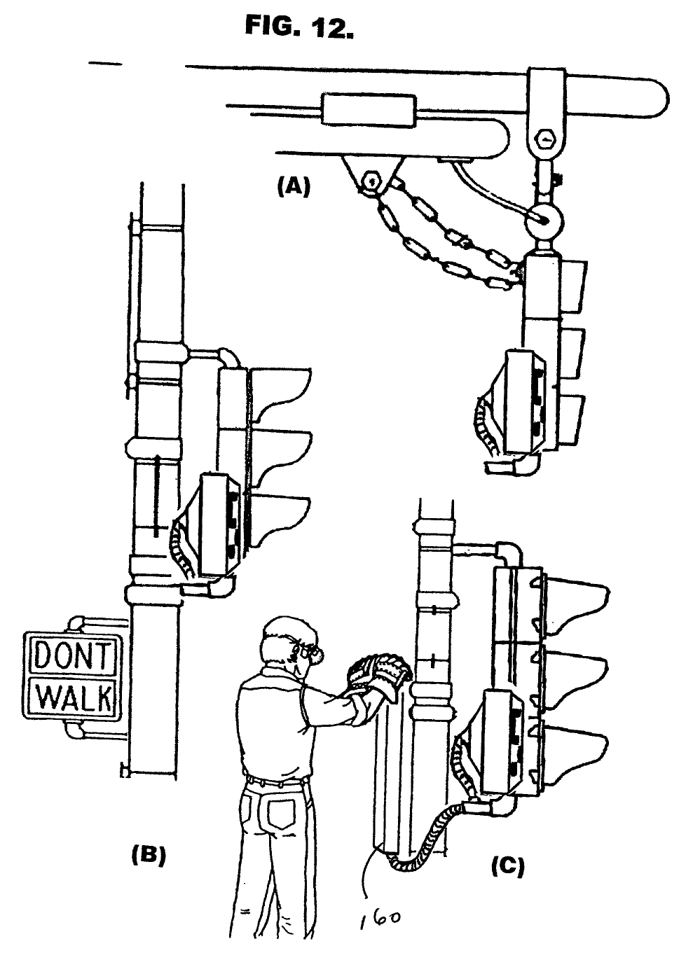

FIG. 12 shows various means of attachment of the signal change indicator system to traffic lights. FIG. 12A shows suspension of the system as described previously. FIG. 12B shows attachment to a pole, and FIG. 12C shows attachment to a pole with an accompanying transformer 160.

The present invention relates to the field of safety enhancing traffic signal control devices, and more specifically to a system that may be used to accessorize a currently in-use, standard, conventional, three or more signal traffic light assembly by providing an additional safety enhancing feature through the implementation of a visual time indicating display mounted parallel and visually in-line with the green signal lamp that will indicate the final seconds, e.g. final five seconds, remaining in the duration of illumination of the green signal indicator lamp.

At the present state of the art, drivers of vehicles approaching signal controlled intersections, possibly at substantial speeds, have no way of determining precisely when the green traffic signal will come to an end, in which case the abrupt appearance of the amber signal creates a potentially dangerous moment of indecisiveness for such drivers. Within the context of a conventional traffic light assembly, the amber signal is essentially intended as a warning of the impending red signal requiring the driver to bring a vehicle to a complete stop. The indeterminable, unpredictable and very abrupt appearance of the amber signal following the green signal fails to provide sufficient reaction time to drivers and therefore fails to perform this function. The present invention is intended to overcome this problem.

It is understood that the present invention may be utilized with a variety of types of traffic lights, including green lights, green directional arrows and flashing green lights. Each such green light should have a timing module (numerical display) associated therewith. However, in particularly preferred embodiments, the present invention is utilized with green lights for through traffic.

1. A signal change indicator system for a traffic control system, said traffic control system having green, amber and red lights disposed and lit in sequence for said control of traffic, said signal change indicator system having a numerical display showing time in seconds, said numerical display being adjacent to and visually aligned with the green light and showing a predetermined number of seconds remaining prior to a signal change from green light to amber light.

2. The signal change indicator system of claim 1 in which the numerical display shows not more than the final ten seconds prior to a signal change from green light to amber light.

3. The signal change indicator system of claim 2 in which the numerical display is blank at all times other than during said display of time remaining prior to a signal change from green light to amber light.

4. The signal change indicator system of claim 3 in which the numerical display shows not more than the final five seconds of said green light prior to a signal change from green light to amber light.

5. The signal change indicator system of claim 2 in which the numerical display is additionally shown at a location spaced from said green light, in advance of the traffic control system.

6. The signal change indicator system of claim 1 in which the numerical display ceases when the traffic light changes from green to amber.

7. The signal change indicator system of claim 3 in which the traffic control system has more than one green light oriented in a direction, each of said green lights having a numerical display associated therewith.

8. The signal change indicator system of claim 7 in which the green light shows directional arrows.

9. The signal change indicator system of claim 7 in which the green light includes a flashing green light and a continuous green light, each of said flashing green light and continuous green light having a numerical display associated therewith.

10. A numerical countdown display in modular form for vehicular traffic lights having green, amber and red lights disposed and lit in sequence for control of traffic, said timing module system having a numerical display showing a pre-determined time in seconds remaining prior to a signal change from green light to amber light, said numerical display being blank at all times other than during said display of time remaining prior to the signal change from green light to amber light.

11. The numerical countdown display in modular form of claim 10 in which the pre-determined seconds are not more than ten seconds.

12. The numerical countdown display in modular form of claim 11 in which the pre-determined seconds are not more than five seconds.

13. The numerical countdown display of modular form of claim 10 in which the numerical display is adjacent to and visually aligned with the green light.

14. An attachment for an in-use traffic light assembly consisting of a red, amber, and green lights, said attachment being mounted and secured parallel and visually in-line with the green light to function as a traffic warning device, said attachment having a real-time, numerical visual display countdown indicating a final pre-determined number of seconds of the duration of illumination of the green light, the visual display countdown ceasing to function simultaneously with a change of the lights in said traffic assembly from a green light to an amber light and functioning again only when the green light is illuminated and then only when the green light has the pre-determined number of seconds prior to a change to amber light at which time the visual display is reactivated and functions until the green light changes to amber, thereby providing a precise warning indication of the moment of change of the lights of the traffic light assembly from green light to amber light.

15. The attachment of claim 14 further comprising
a) a digital processing means to control said countdown; and
b) a timer that is activated by said digital processor to effect said visual display.

16. The attachment of claim 14 further comprising:
i) an integrated circuit with digital processing, logic and memory means to control said countdown; and
ii) a timer that is activated by said processing, logic and memory to effect said visual display.

17. The attachment of claim 16 in which the final pre-determined number of seconds is not more than ten.

18. The attachment of claim 16 in which the final pre-determined number of seconds is five.

19. The attachment of claim 16 in which said visual display has dimensions not exceeding 50 cm in height and 40 cm in width.

20. A signal change indicator system for a traffic control system having green, amber and red lights disposed and lit in sequence for said control of traffic, said signal change indicator system having a numerical display countdown showing time in seconds remaining prior to a signal change from green light to amber light, said numerical display being adjacent to and aligned with the green light and showing the final five seconds of signal duration prior to the signal change from green light to amber light.

21. The signal change indicator system of claim 20 in which said numerical display has dimensions not exceeding 50 cm in height and 40 cm in width.
